(19) United States
(12) Patent Application Publication
(10) Pub. No.: US 2011/0135307 A1
(43) Pub. Date: Jun. 9, 2011

(54) Fiber Optic Terminals, Systems, and Methods for Network Service Management

(76) Inventors: Mark E. Conner, Granite Falls, NC (US); Kenneth F. Dunn, JR., Statesville, NC (US)

(21) Appl. No.: 12/630,938

(22) Filed: Dec. 4, 2009

(51) Int. Cl. H04J 14/00

(52) U.S. Cl. 398/72; 398/139

(57) ABSTRACT

Fiber optic terminals, systems, and methods for providing differentiated network services to subscribers of a fiber optic network are disclosed. In certain embodiments, fiber optic terminals and methods are disclosed for providing more than one network service to subscribers supported by the same fiber optic terminal. In one embodiment, a fiber optic terminal is provided comprising a first optical path connected to a first network-side optical fiber providing a first network service to a first subscriber-side optical fiber. The fiber optic terminal also comprises a second optical path connected to a second network-side optical fiber providing a second network service differentiated from the first network service to a second subscriber-side optical fiber. In this manner, differentiated network services can be provided to subscribers supported by the fiber optic terminal by configuring connections of the subscribers to either the first optical path or second optical path in the fiber optic terminal.

### BACKGROUND

1. Field of the Disclosure

The technology of the disclosure relates to fiber optic terminals, systems, and methods for providing differentiated network services and/or differentiated network service overlays to subscribers of a fiber optic network.

2. Technical Background

To provide improved performance to subscribers, communication and data networks are increasingly employing optical fiber. The benefits of optical fiber are well known and include higher signal-to-noise ratios and increased bandwidth. To further improve performance, fiber optic networks are increasingly providing optical fiber connectivity all the way to end subscribers. These initiatives include various fiber-to-the-premises (FTTP), fiber-to-the-home (FTTH), and other fiber initiatives (generally described as FTTx). In this regard, FIG. 1 illustrates an exemplary fiber optic network 10. The fiber optic network 10 in this example is a passive optical network (PON). A PON is a point-to-multipoint FTTx network architecture to enable an optical fiber to serve multiple premises. A PON configuration generally reduces the amount of optical fiber and central office equipment as compared with point-to-point optical network architectures.

The fiber optic network 10 in FIG. 1 provides optical signals from switching points 12 over a distribution network 13 comprised of fiber optic feeder cables 14. The switching points 12 include optical line terminals (OLTs) or forward lasers/return receivers 15 that convert electrical signals to and from optical signals. The optical signals may then be carried over the fiber optic feeder cables 14 to local convergence points (LCPs) 16. The LCPs 16 act as consolidation points for splicing and making cross-connections and interconnections, as well as providing locations for optical couplers and splitters. The optical couplers and splitters in the LCPs 16 enable a single optical fiber to serve multiple subscriber premises 20. Fiber optic cables 18, such as distribution cables, exit the LCPs 16 to carry optical signals between the fiber optic network 10 and the subscriber premises 20. Typical subscriber premises 20 include single-dwelling units (SDU), multi-dwelling units (MDU), businesses, and/or other facilities or buildings. End subscribers in the subscriber premises 20 may contain network devices configured to receive electrical signals as opposed to optical signals. Thus, optical network terminals (ONTs) and/or optical network units (ONUs) 21 may be provided at the subscriber premises 20 to convert optical signals received over the fiber optic cables 18 to electronic signals.

Because LCPs 16 are typically configured to service multiple premises 20, the fiber optic cables 18 leaving the LCPs 16 are typically run to one or more intermediate fiber distribution terminals (FDTs) 22. FDTs 22 facilitate FTTx applications by providing network access points to the fiber optic network 10 to groupings of subscriber premises 20. Optical interconnections to the subscriber premises 20 are typically provided via indoor/outdoor drop cables 24 that are optically interconnected with the fiber optic cables 18 within the FDTs 22. The FDTs 22 also provide a consolidated location for technicians or other installation personnel to make and protect splices and/or connections between the drop cables 24 and the fiber optic cables 18 as opposed to making splices and/or connections in sporadic locations.

The fiber optic network 10 is capable of providing different levels of network services to subscriber premises 20 and different end subscribers at multi-unit subscriber premises 20. In this manner, different end subscribers can be charged at different rates based on their selected level of service. For example, the fiber optic network 10 may be capable of providing a premium, faster data-rate service to subscriber premises 20. However, some end subscribers at subscriber premises 20 may not need or desire the bandwidth provided in the premium data service. In this regard, the ONT and/or ONU 21 deployed at the subscriber premises 20 may be configured to control the level of service to only allow a standard, slower data-rate service. This is because the fiber optic network 10 in FIG. 1 is homogeneous, meaning the highest level of service available is provided over all fiber optic feeder cables 14 and fiber optic cables 18 regardless of whether each subscriber premises 20 has subscribed to the highest level of service.

When setting up a PON, service operators must consider providing ONUs that support differentiated services, such as higher bandwidth services and/or packet delivery assured services to service future potential increased bandwidth needs and demands of end subscribers. Some examples of these services include Ethernet PON (EPON), Gigabit PON (GPON), ten (10) Gigabit EPON (10G-EPON), 10G-GPON, WDM-based network services, such as for example, Wave Division Multiplexing PON (WDM-PON). The ONUs must be configured to recognize and transfer PON services provided by the PON. One approach is to delay providing ONUs that support differentiated PON services until demand or need exists. The initial costs may be less using this approach. However, this approach would also require eventually swapping-out initially installed ONUs with ONUs that support the differentiated PON services supported by the PON, thus increasing total cost and potentially disrupting service to subscribers.

Another approach is to initially pre-position ONUs capable of supporting differentiated PON services (e.g., EPON, GPON, 10G-EPON, 10G-GPON, and WDM-PON) in advance of supporting revenue streams. This approach may be necessary if it is desired to provide certain end subscribers with differentiated services. It may also be desired to provide different types of PON services to different end subscribers which may be closely located to each other. For example, it may be desirable to service closely located business end subscribers and residential end subscribers off of the same network even though business subscribers typically subscribe to differentiated PON services. However, initial costs of providing ONUs capable of supporting differentiated PON services may be initially higher than using the delay approach.

### SUMMARY OF THE DETAILED DESCRIPTION

Embodiments disclosed in the detailed description include fiber optic terminals, systems, and methods for providing different (i.e., differentiated) network services to subscribers of a fiber optic network. A network service refers to a technology or platform used to carry or deliver an application, product, or service. In certain embodiments, fiber optic terminals, systems, and methods are disclosed for providing more than one network service over a fiber optic network to subscribers supported by the same fiber optic terminal. As a result, the optical paths in the fiber optic terminal do not have to be homogeneous wherein each optical path would carry the same optical signals and thus the same network services. Thus, differentiated levels and/or types of network services can be provided to different subscribers supported by the same fiber optic terminal. Further, by providing multiple optical paths in the fiber optic terminal, additional network services can be migrated to a fiber optic terminal, wherein subscribers supported by the same fiber optic terminal can subscribe to different services. Further, the network services provided to a subscriber supported by the fiber optic terminal can be reconfigured by changing the optical path connected to the subscriber in the fiber optic terminal. Further, by employing the fiber optic terminal, it may not be necessary to provide or upgrade optical network terminals (ONTs) or optical network units (ONUs) for subscribers to discriminate between different types of network services since the optical paths in the fiber optic terminal are not homogeneous.

In this regard, in one embodiment, a fiber optic terminal is provided. The fiber optic terminal comprises a first optical path connected to a first network-side optical fiber providing a first network service to a first subscriber-side optical fiber. The fiber optic terminal also comprises a second optical path connected to a second network-side optical fiber providing a second network service different from the first network service to a second subscriber-side optical fiber. In this manner, different or differentiated network services can be provided to different subscribers supported by the same fiber optic terminal by connecting subscribers to an optical path in the fiber optic terminal providing the desired network services. The fiber optic terminal can become the management point to connect subscribers to the desired network services. The network services provided on the optical paths in the fiber optic terminals may also be overlays of multiple network services.

In other embodiments, methods of providing at least two different network services to subscribers supported by a fiber optic terminal are disclosed. In one embodiment, the method comprises providing a fiber optic terminal. The method also comprises connecting a first optical path in the fiber optic terminal to a first network-side optical fiber providing a first network service. The method further comprises connecting the first optical path to at least one first subscriber-side optical fiber to provide the first network service to at least one first subscriber connected to the at least one first subscriber-side optical fiber. The method also comprises connecting a second optical path in the fiber optic terminal to a second network-side optical fiber providing a second network service different from the first network service.

In other embodiments, fiber optic systems are disclosed. In one embodiment, a fiber optic system comprises a network-side fiber optic terminal. The network-side fiber optic terminal comprises a first network-side optical path connected to a first network-side optical fiber providing a first network service to a first optical fiber. The network-side fiber optic terminal also comprises a second network-side optical path connected to a second network-side optical fiber providing a second network service different from the first network service to a second optical fiber. The fiber optic system also comprises a first subscriber-side fiber optic terminal comprising a first optical path connected to the first optical fiber to provide the first network service to at least one first subscriber connected to the first subscriber-side fiber optic terminal. In this manner, the connection of the first subscriber-side terminal to the first optical fiber provides the first network service provided by the network-side fiber optic terminal to subscribers supported by the first subscriber-side fiber optic terminal. In this manner, the network service provided to the first subscriber-side network terminal is controlled by the connection of the first optical path to an optical fiber from the network-side fiber optic terminal.

The fiber optic terminals can be any type of fiber optic terminal. Examples include local convergence points (LCPs) and fiber distribution terminals (FDTs). The fiber optic terminals can support subscriber premises, end subscribers, or other subscribers on the network-side of end subscribers or subscriber premises. The first and/or second optical paths may include optical splitters to split the first and/or second network services provided to multiple subscribers supported by the fiber optic terminal. Further, the first and/or second optical paths may include non-split fiber optic connections to provide a network service carried over an optical path to a single subscriber supported by the fiber optic terminal.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 illustrates an exemplary passive optical network (PON) that includes optical network terminals (ONTs) and optical network units (ONUs) for converting electrical signals to optical signals, and vice versa, and fiber optic terminals for carrying optical signals over a fiber optic network;

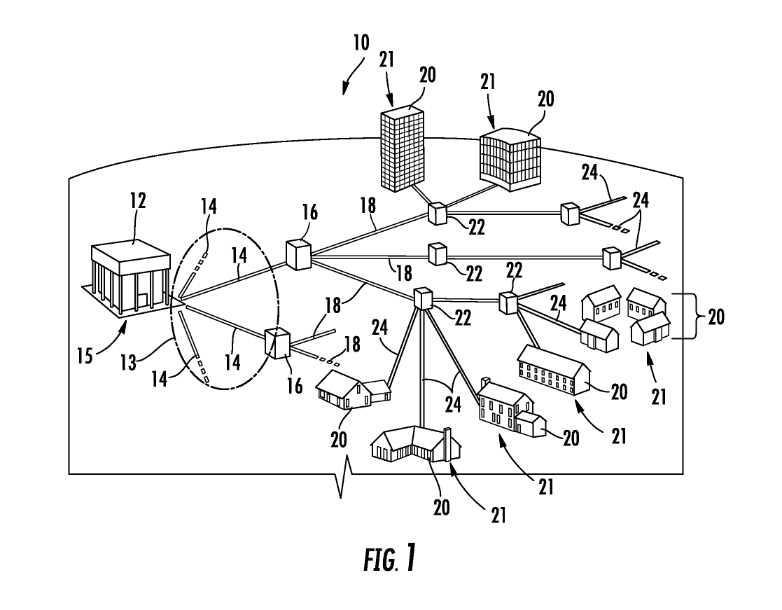

FIG. 2 illustrates an exemplary multi-dwelling unit (MDU) that includes fiber optic terminals that include local convergence points (LCPs) and fiber distribution terminals (FDTs) providing connectivity of end subscribers to the fiber optic network;

FIG. 3 is a block diagram of an exemplary fiber optic terminal employing a first non-split optical path and a second optical path employing an optical splitter, wherein each optical path supports different network services in a centralized manner;

FIG. 4 is a block diagram of another exemplary fiber optic terminal employing optical splitters in each optical path, wherein each optical path supports different network services in a centralized manner;

FIG. 5 is a block diagram of an exemplary network-side fiber optic terminal providing one or more network services to subscribers supported by one or more subscriber-side fiber optic terminal(s) connected to the network-side fiber optic terminal in a distributed manner;

FIG. 6 is an exemplary fiber optic terminal that may be employed as any of the aforementioned fiber optic terminals; and

FIG. 7 illustrates the fiber optic terminal of FIG. 6 with a terminal cover closed.

### DETAILED DESCRIPTION OF THE PREFERRED EMBODIMENTS

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include fiber optic terminals, systems, and methods for providing different (i.e., differentiated) network services to subscribers of a fiber optic network. A network service refers to a technology or platform used to carry or deliver an application, product, or service. In certain embodiments, fiber optic terminals, systems, and methods are disclosed for providing more than one network service over a fiber optic network to subscribers supported by the same fiber optic terminal. As a result, the optical paths in the fiber optic terminal do not have to be homogeneous wherein each optical path would carry the same optical signals and thus the same network services. Thus, differentiated levels and/or types of network services can be provided to different subscribers supported by the same fiber optic terminal. Further, by providing multiple optical paths in the fiber optic terminal, additional network services can be migrated to a fiber optic terminal, wherein subscribers supported by the same fiber optic terminal can subscribe to different services. As an example, the fiber optic terminal may allow a service operator to design a network that initially provides Radio Frequency over Glass (RFoG) based services to subscribers, but the network and the fiber optic terminal may be later migrated to additionally provide differentiated PON services (e.g., EPON, GPON, 10G-EPON, 10G-GPON, and WDM-PON), including but not limited to higher bandwidth services, to subscribers supported by the fiber optic terminal. The network services provided to a subscriber supported by the fiber optic terminal can be reconfigured by changing the optical path connected to the subscriber in the fiber optic terminal. Further, by employing the fiber optic terminal, it may not be necessary to provide or upgrade optical network terminals (ONTs) or optical network units (ONUs) for subscribers to discriminate between different types of network services since the optical paths in the fiber optic terminal are not homogeneous.

In this regard, in one embodiment, a fiber optic terminal is provided. The fiber optic terminal comprises a first optical path connected to a first network-side optical fiber providing a first network service to a first subscriber-side optical fiber. The fiber optic terminal also comprises a second optical path connected to a second network-side optical fiber providing a second network service different from the first network service to a second subscriber-side optical fiber. In this manner, different network services can be provided to different subscribers supported by the same fiber optic terminal by connecting subscribers to an optical path in the fiber optic terminal providing the desired network services. The fiber optic terminal can become the management point to connect subscribers to the desired network services. The network services provided on the optical paths in the fiber optic terminals may also be overlays of multiple network services (e.g., provided over the same fiber).

The fiber optic terminals disclosed herein may be used for any type of fiber optic terminal, including but not limited to local convergence points (LCPs) and fiber distribution terminals (FDTs). For example, if the fiber optic terminal is configured as a local convergence point (LCP), the network-side or upstream fiber optic cable may be a feeder cable from a central office, head end, or switching point. The subscriber-side or downstream fiber optic cable may be a distribution cable. If the fiber optic terminal is configured as an FDT, the network-side or upstream fiber optic cable may be a distribution cable, and the subscriber-side or downstream fiber optic cable may be a drop cable. The drop cable may then be routed to an end subscriber(s) for FTTx applications.

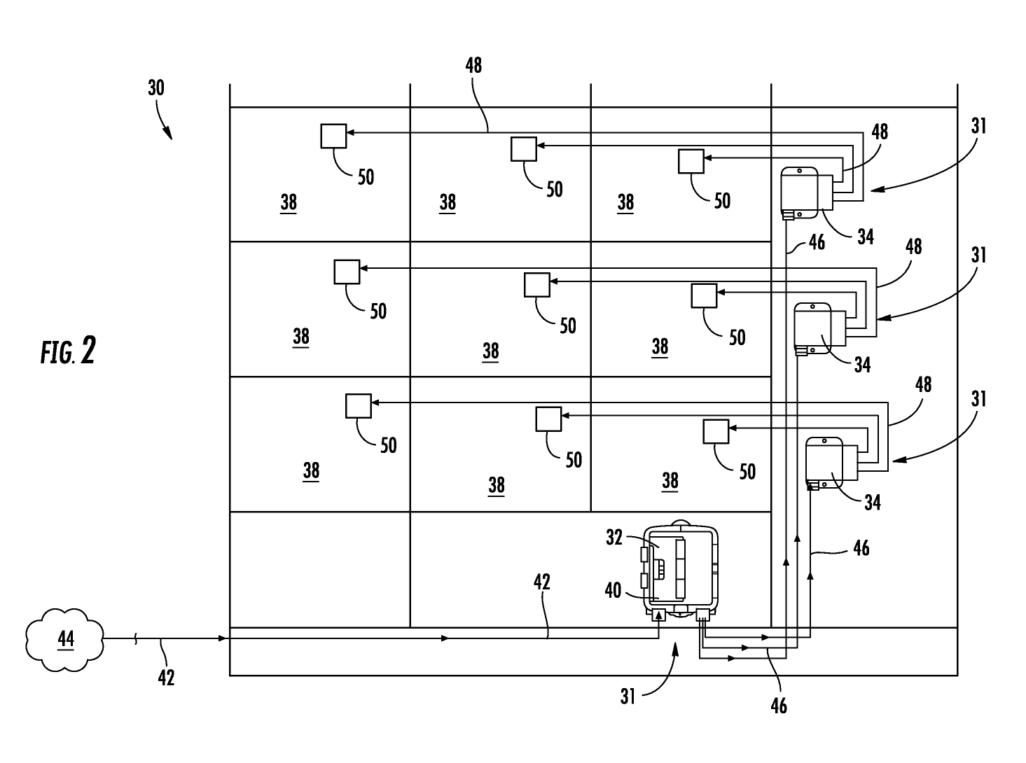

The fiber optic terminals disclosed herein may be installed in any location or premises. The fiber optic terminal may be employed for providing fiber optic network connectivity to end subscribers in multi-dwelling units (MDUs). In this regard, FIG. 2 illustrates a MDU 30 that includes fiber optic terminals 31 that may be employed as both LCPs 32 and FDTs 34. If the fiber optic terminal is configured as an FDT, the network-side or upstream fiber optic cable may be a distribution cable, and the subscriber-side or downstream fiber optic cable may be a drop cable. The drop cable may then be routed to an end subscriber(s) for FTTx applications.

The fiber optic terminals 31 provide convenient access points in a telecommunications or data network for a field technician to install and reconfigure optical fiber connections between network-side and subscriber-side fiber optic cables. The fiber optic terminals 31 are configured to allow one or more optical fibers provided in one or more network-side or upstream fiber optic cables to be easily and readily interconnected with one or more optical fibers in one or more subscriber-side or downstream fiber optic cables. By the term “subscriber-side,” it is meant that optical fiber, fiber optic cable, or optical connection, as the case may be, is provided anywhere between the end subscriber and the fiber optic terminals 31. A subscriber-side fiber optic cable, optical fiber, or optical connection may be provided directly to an end subscriber or may be provided to one or more intermediate optical terminals or components before reaching an end subscriber. By the term “network-side,” it is meant that the optical fiber, fiber optic cable, or optical connection, as the case may be, is provided between a fiber optic network, central switching point, central office, head end, or the like and the fiber optic terminals 31.

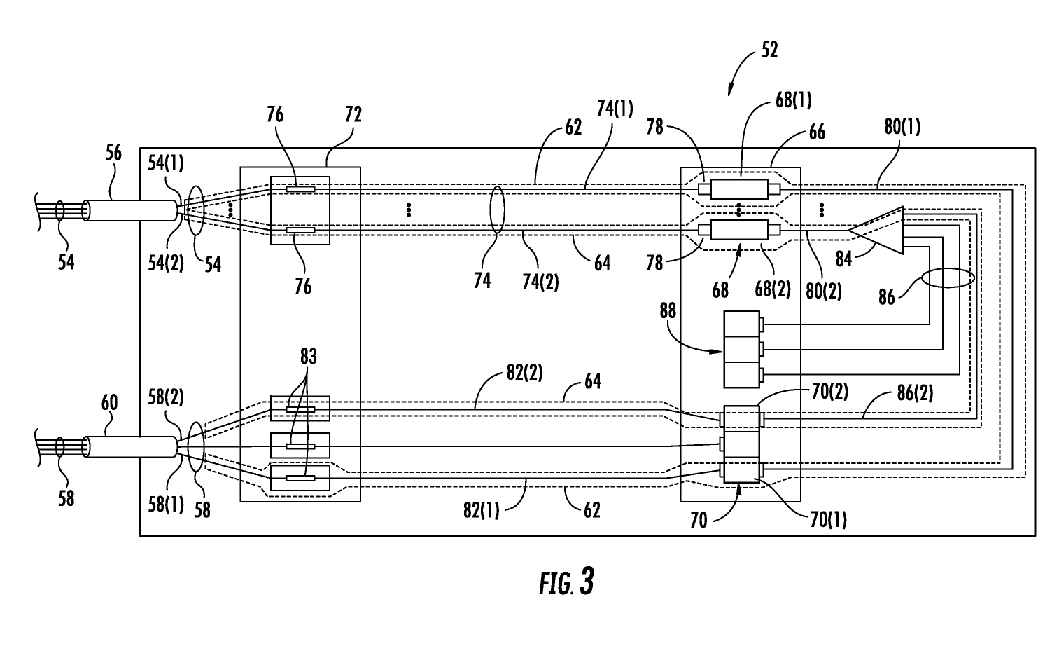

Before discussing various embodiments of fiber optic terminals that may be employed starting at FIG. 3, the exemplary MDU 30 in FIG. 2 is first discussed in more detail. In this regard, the MDU 30 in this example includes nine (9) dwelling units 38 for illustrative purposes only. In this embodiment, the LCP 32 is positioned on the ground floor or basement in the illustrated embodiment; however, the LCP 32 could be positioned at any location relative to the MDU 30. The LCP 32 includes a cable assembly 40 that is optically connected to a network-side fiber optic cable 42. For example, the network-side fiber optic cable 42 may be a feeder cable optically connected to a central office (not shown) or switching point (not shown) through a fiber optic network 44. One or more subscriber-side optical fibers 46 carrying optical signals can be optically connected in or at the LCP 32 to the fiber optic network 44 and exit the LCP 32 to extend throughout the MDU. For example, the subscriber-side optical fibers 46 may be distribution cables. The network-side fiber optic cables 42 may be feeder cables. The subscriber-side optical fibers 46 carry optical signals to and from the LCP 32 received from the fiber optic network 44 and extend to each dwelling unit 38 via subscriber-side optical fibers 48 and eventually terminate at a subscriber termination point 50, such as an adapter in a wall outlet, an adapter in a floor panel, an adapter behind a ceiling tile, or the like such that the subscriber can optically connect to a subscriber-side optical fiber 48.

The optical fibers extended to the subscriber termination point 50 can be the subscriber-side optical fibers 46, or can be provided by subscriber-side optical fibers 48 from one or more intermediate FDTs 34. The FDTs 34 can be provided to simplify the routing and installation of the subscriber-side optical fibers 48 between the LCP 32 and the subscriber termination points 50 by allowing the subscriber-side optical fibers 48 to be grouped between the LCP 32 and FDTs 34 and then separated at the FDTs 34. The FDTs 34 are configured to receive the subscriber-side optical fibers 46 and provide the individual subscriber-side optical fibers 48 to the subscriber termination points 50. Accordingly, there are fewer optical fibers and/or fiber optic cables extending between the floors of the MDU 30, thus simplifying routing of optical fibers through the MDU 30. Although floors of the MDU 30 are described in the illustrated embodiments, it should be appreciated that FDTs 34 may be used to facilitate optical fiber routing to any layout of areas within the MDU 30. Further, although the subscriber-side optical fibers 48 and subscriber-side optical fibers 46 include arrows pointing in the direction of the subscriber termination points 50, it should be appreciated that optical signals may be passed in either direction as required for the particular application; the arrows are merely provided for illustrative purposes.

A block diagram of an exemplary embodiment of a fiber optic terminal 52 according to one embodiment is illustrated in FIG. 3. The fiber optic terminal 52 in FIG. 3 may be provided as the fiber optic terminals 31 in FIG. 2, including the LCPs 32 and FDTs 34 provided therein, as examples. As will be described in greater detail below, the fiber optic terminal 52 in this embodiment employs multiple optical paths that receive optical signals from a plurality of network-side optical fibers 54 disposed in a network-side fiber optic cable 56. The network-side optical fibers 54 provide optical signals for a plurality of network services. The fiber optic terminal 52 facilitates providing the plurality of network services to subscribers (not shown) over subscriber-side optical fibers 58 disposed in a subscriber-side fiber optic cable 60. In this manner, different network services can be provided to different subscribers supported by the same fiber optic terminal 52 by connecting subscribers to the optical path in the fiber optic terminal 52 providing the desired network services. In this regard, the fiber optic terminal 52 provides different network services to subscribers in a centralized manner. As a result, the optical paths in the fiber optic terminal 52 do not have to be homogeneous, meaning each optical path carries the same optical signals and thus the same network services.

Different levels and/or types of network services can be provided to different subscribers supported by the fiber optic terminal 52. For example, as illustrated in FIG. 3, a first optical path 62 provided in the fiber optic terminal 52 may be connected to a first network-side optical fiber 54(1) providing Radio Frequency over Glass (RFoG) based network services. RFoG is compatible with head-end equipment in existing hybrid fiber coaxial (HFC) networks, and may provide voice, video, data, and/or services. A second optical path 64 provided in the fiber optic terminal 52 may be connected to a second network-side optical fiber 54(2) providing Ethernet Passive Optical Network (EPON) based network services. Thus, a first subscriber-side optical fiber(s) 58(1) connected to the first optical path 62 and the first subscriber-side optical fiber(s) 54(1) provides RFoG-based network services to subscribers connect thereto. A second subscriber-side optical fiber(s) 58(2) connected to the second optical path 64 and the second network-side optical fiber 54(2) provides EPON-based network services in this embodiment. In this manner, the fiber optic terminal 52 allows providing different network services to different subscribers supported by the fiber optic terminal 52. Thus, discriminating between different types of network services through use of ONTs or ONUs at end subscribers may not be required to provide different network services to different subscribers supported by the fiber optic terminal 52. Further, if at a later time it is desired, for example, to provide EPON-based network services to the first subscriber-side optical fiber 58(1), the connection of the first subscriber-side optical fiber 58(1) can be moved or relocated to be connected to the second optical path 64 and the second network-side optical fiber 54(2) in the fiber optic terminal 52.

The fiber optic terminal 52 in FIG. 3 also supports overlaying of multiple network services in the first and second optical paths 62, 64. For example, optical signals providing EPON-based network services carried on the network-side optical fiber 54(2) may be overlaid onto optical signals providing RFoG-based network services carried on the same network-side optical fiber 54(1). Overlaying means providing multiple optical signals over the same optical fiber (e.g., using wave division multiplexing (WDM) or time division multiplexing (TDM)). Overlaying of optical signals is possible where the overlaid network services are provided by optical signals having different wavelengths. This provides for greater flexibility in providing enhanced network services. As an example, the first and second optical paths 62, 64 in the fiber optic terminal 52 may initially be connected to network-side optical fibers 54 that provide only one network service, for example, a RFoG-based network service. Later, when it is desired to provide enhanced bandwidth, additional network services, such as EPON-based or GPON-based network services as examples, can be overlaid on network-side optical fibers 54 such that one optical path 62 or 64 as the case may be, may provide network services using a combination of RFoG-based and EPON-based services to subscribers and the other optical path 64 or 62 may provide only network services using RFoG. For example, RFoG may provide video services, and EPON or GPON provide data and voice services. Thus, the providing of non-homogeneous optical paths in the fiber optic terminal 52 facilitates easy migration to differentiated network services, which includes but is not limited to higher bandwidth network services.

With continuing reference to FIG. 3, the fiber optic terminal 52, the network-side optical fibers 54 from the network-side fiber optic cable 56, and the subscriber-side optical fibers 58 from the subscriber-side fiber optic cable 60 are optically connected to each other at a fiber optic connection panel 66 disposed in the fiber optic terminal 52 in this embodiment. The fiber optic connection panel 66 can be a panel or module that contains or supports a plurality of optical fiber connections. The fiber optic connection panel 66 may support one or more input fiber optic adapters 68 and one or more output fiber optic adapters 70 for supporting optical fiber connections. The input and output fiber optic adapters 68, 70 support making optical connections between the one or more network-side optical fibers 54 from the network-side fiber optic cable 56 and the one or more subscriber-side optical fibers 58 from the subscriber-side fiber optic cable 60. The input and output fiber optic adapters 68, 70 may be of any connection type, including but not limited to SC, LC, MTP, FC, ST, MU, or MTRJ.

With continuing reference to FIG. 3, to make an optical connection between the one or more network-side optical fibers 54, the one or more network-side optical fibers 54 are spliced in a splice tray 72 to an input pigtail(s) 74 in a network splice(s) 76 in this embodiment. However, the fiber optic terminal 52 could be configured to not require splicing. The input pigtail(s) 74 is connected on a connectorized end(s) 78 to the input fiber optic adapter(s) 68. In this embodiment, a first input pigtail 74(1) optically connected to the first network-side optical fiber 54(1) is connected to an input fiber optic adapter 68(1). An output fiber 80(1) is connected between the input fiber optic adapter 68(1) and an output fiber optic adapter 70(1) to optically connect the network-side optical fiber 54(1) to an output pigtail 82(1). The output pigtail 82(1) is spliced, via splices 83 in the splice tray 72, into the subscriber-side optical fiber 58(1) in the subscriber-side fiber optic cable 60. Again, splicing may not be required. In this manner, an optical connection is made between the network-side optical fiber 54(1) and subscriber-side network optical fiber(s) 58(1) to provide the first network service to a subscriber connected to the subscriber-side optical 58(1) fiber.

Also in this embodiment of the fiber optic terminal 52, a second input pigtail 74(2) optically connected to the second network-side optical fiber 54(2) is connected to an input fiber optic adapter 68(2). The input fiber optic adapter 68(2) is connected to an output fiber 80(2) which is an input into an optical splitter 84 provided in the second optical path 64. The optical splitter 84 is configured to split optical signals carried by the input fiber 80(2), via connection to the input fiber optic adapter 68(2), into a plurality of optical signals carried by multiple connectorized output fibers 86(2). For example, the optical splitter 84 in FIG. 3 is a 1×4 optical splitter, but any other type of splitting configuration may be provided. Providing the optical splitter 84 in the second optical path 64 allows more than one subscriber-side optical fiber 58 to be connected to the second optical path 64 and thus receive the second network service, if desired. The splitter configuration of the optical splitter 84 depends on the number of subscribers desired to be provided with the second network service in this embodiment. For example, a 1×8 optical splitter allows the second optical path 64 to be connected to up to eight (8) subscriber-side optical fibers 58.

With continuing reference to FIG. 3, one or more of the output fibers 86 can then be connected into one or more of the output fiber optic adapters 70 to optically connect to the output pigtails 82. In this embodiment, one of the output fibers 86(2) is connected to the output fiber optic adapter 70(2), which is optically connected to output pigtail 82(2). The output pigtail 82(2) is spliced, via the splice tray 72, into the subscriber-side optical fiber(s) 58(2) in the subscriber-side fiber optic cable 60. In this manner, an optical connection is made between the network-side optical fiber 54(2) and subscriber-side optical fiber(s) 58(2) to provide the second network service to a subscriber connected to the subscriber-side optical fiber 58(2).

If it is later desired to change, move, or relocate the subscriber-side optical fiber 58(1) to the second network service over the second optical path 64, the output pigtail 82(1) can be connected to the optical splitter 84 through the fiber optic adapter 70 easily and quickly. In this regard, one of the output fibers 86 from the optical splitter 84 may need to be moved from a parking area 88, where unused output fibers are parked, to a connection with an available output fiber optic adapter 70 that is connected to the output pigtail 82(1). In the embodiment shown in FIG. 3, it is not possible to connect more than one subscriber-side optical fiber 58 to the first optical path 62 to receive the first network service since only one input fiber optic adapter 68(1) is provided in the first optical path 62. If it is desired to provide the ability for multiple subscriber-side optical fibers 58 to be connected to the first optical path 62 to receive the first network services, the fiber optic terminal 52 can be expanded by also providing an optical splitter in the first optical path 62.

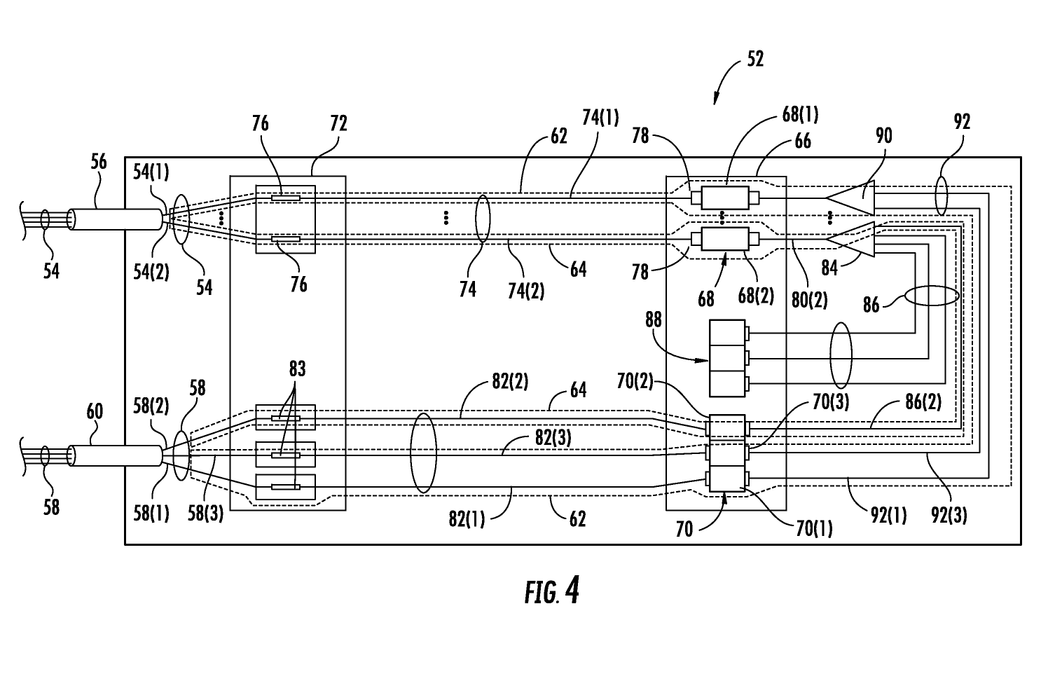

In this regard, FIG. 4 provides the fiber optic terminal 52 of FIG. 3, except that an optical splitter 90 is also provided in the first optical path 62. In this manner, network services from the first network-side optical fiber 54(1) can also be split into a plurality of output signals carried by multiple connectorized output fibers 92 that can be connected to one (1) or more subscriber-side optical fiber 58 to provide expansion of the first network service to additional subscribers, if needed or desired. Connectorized output fibers 92(1), 92(2) from the optical splitter 90 are connected to output fiber optic adapters 70(1), 70(3), which are in turn connected to output pigtails 82(1), 82(3), respectively. The output pigtails 82(1), 82(3) are connected to subscriber-side optical fibers 58(1), 58(3). In this regard, the first network services provided in the first optical path 62 can be provided to two (2) subscribers connected to subscriber-side optical fibers 58(1), 58(3) in this embodiment. If it is desired to move, change, or relocate any subscribers from the first network service to the second network service, or vice versa, the subscriber-side optical fiber(s) 58 connected to such subscriber can be moved or relocated from the first optical path 62 (e.g., the optical splitter 90) to the second optical path 64 (e.g., the optical splitter 84), or vice versa. For example, if it is desired to move, change, or relocate a subscriber connected to subscriber-side optical fiber 58(1) from the first network service to the second network service, the output pigtail 82(1) can be moved or relocated to the output fiber optic adapter 70(2), or alternatively, output fiber 92(1) from the optical splitter 90 can be moved or relocated to output fiber optic adapter 70(2).

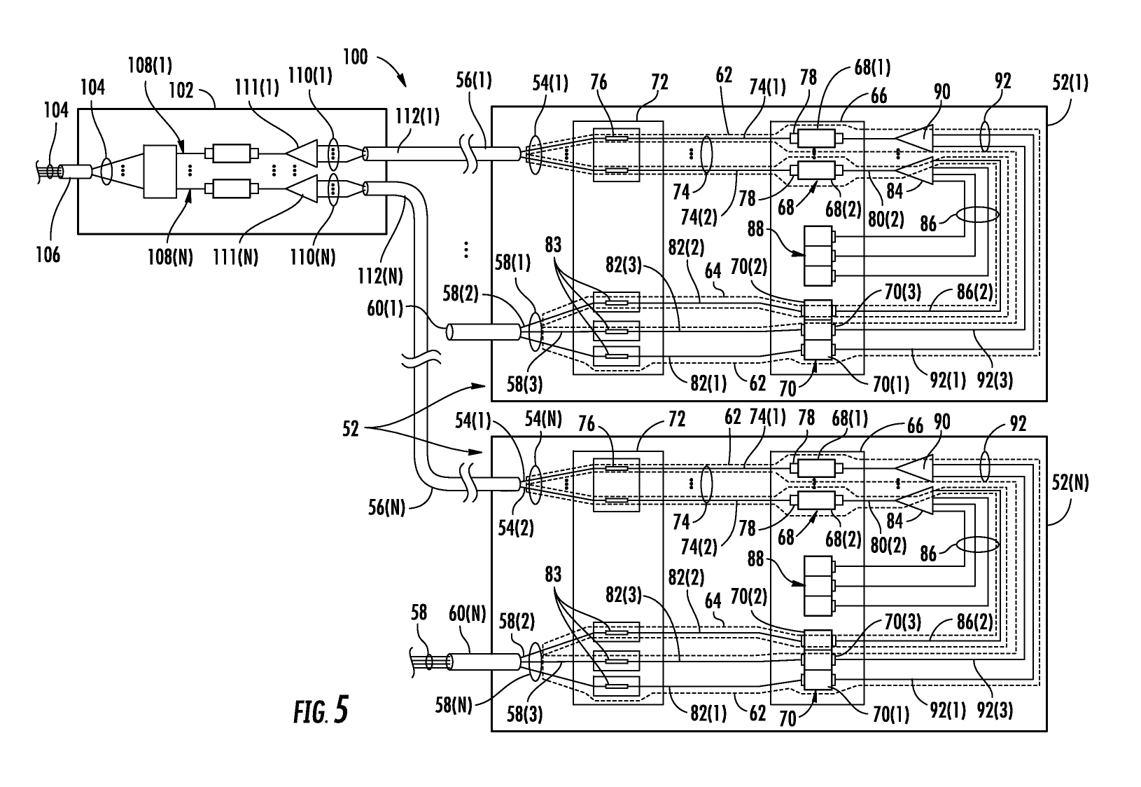

FIG. 5 illustrates another embodiment where a fiber optic system 100 is provided that includes at least one network-side fiber optic terminal 102 to support providing multiple network services to multiple fiber optic terminals in a distributed manner. In this embodiment, the network-side fiber optic terminal 102 is configured to provide optical signals for more than one network service from a fiber optic network (not shown) received over multiple network-side optical fibers 104 provided in a network-side fiber optical cable 106. In this regard, the network-side fiber optic terminal 102 may be configured like any configurations provided for the fiber optic terminals 52 previously discussed, as an example. The network-side fiber optic terminal 102 can be configured to provide multiple (N) optical paths 108(1)-108(N) to provide multiple network services like configured in the fiber optic terminals 52 previously described.

In this embodiment, subscriber-side optical fibers 110(1) provided in a fiber optic cable 112(1) are connected to a network service to the optical path 108(1) in the network-side fiber optic terminal 102 to provide a first network service. The subscriber-side optical fibers 110(1) carry optical signals split by an optical splitter 111(1). The optical signals split by optical splitter 111(1) are carried by network-side optical fibers 54(1) routed to a first subscriber-side fiber optic terminal 52(1) to provide the first network service to the first subscriber-side fiber optic terminal 52(1). The first subscriber-side fiber optic terminal 52(1) can be the fiber optic terminals 52 previously described. In this manner, the network service provided to subscribers supported by the first subscriber-side fiber optic terminal 52(1) is provided through the optical splitter 111(1) in the network-side fiber optic terminal 102 in a distributed manner. However, if optical path 108(N) is connected to network-side optical fibers 106 providing a different network service from the network service provided to the optical path 108(1), and the network-side optical fibers 54(1) are connected to the subscriber-side optical fibers 110(N), a different network service would be provided to the first subscriber-side fiber optic terminal 52(N). Thus, the number of optical paths 108(1)-108(N) in the network-side fiber optic terminal 102 determines the number of different unique network services or network service overlays that can be provided to the first subscriber-side fiber optic terminal 52(1) in the fiber optic system 100 of FIG. 5.

Further, if more than one network service is provided in the subscriber-side optical fibers 110(1) in the network-side fiber optic terminal 102 to the first subscriber-side fiber optic terminal 52(1), the network services provided to subscribers supported by the first subscriber-side fiber optic terminal 52(1) can also be determined in the subscriber-side fiber optic terminal 52 to provide a distributed configuring of network services. Different network services can be provided in different optical paths, for example, the first and second optical paths 62, 64, within the first subscriber-side fiber optic terminal 52(1) and provided to different subscriber-side optical fibers 58(1), as previously described with regard to FIGS. 3 and 4. For example, the optical splitter 111(1) in the fiber optic terminal 102 may be a 1×4 splitter and the optical splitters 84, 90 in the fiber optic terminal 52(1) may be 1×2 splitters, as opposed to, for example, only providing a 1×8 optical splitter in the fiber optic terminal 52(1).

FIG. 5 also includes additional subscriber-side fiber optic terminals 52 signified by the inclusion of subscriber-side fiber optic terminal 52(N) to signify that “N” number of subscriber-side fiber optic terminals 52 can be provided, wherein “N” is any natural number. Multiple subscriber-side fiber optic terminals among subscriber-side fiber optic terminals 52(1)-52(N) may be provided, wherein each subscriber-side fiber optic terminal 52 is connected to a different optical path among optical paths 108(1)-108(N) in the network-side fiber optic terminal 102. Some or all of the optical paths 108(1)-108(N) may have optical splitters 111(1)-111(N) to split optical signals from the network-side optical fibers 106. In this regard, different network services can be provided to multiple subscriber-side fiber optic terminals 52(1)-52(N). The network services provided to the subscriber-side fiber optic terminals 52(1)-52(N) are determined by the optical splitters 111(1)-111(N) determining the optical paths 108(1)-108(N) connected to the subscriber-side fiber optic terminals 52(1)-52(N). Thus, for example, if it is desired to provide different network services to subscribers located in close proximity, multiple subscriber-side fiber optic terminals 52(1)-52(N) can be provided and co-located. Each subscriber-side fiber optic terminal 52(1)-52(N) would provide one or more network services from the network-side fiber optic terminal 102. Subscribers can be connected to the subscriber-side fiber optic terminals 52(1)-52(N) based on the network service to be provided.

The choice between a centralized splitting model, such as for example provided in FIGS. 3 and 4, and a distributed splitting module, such as for example provided in FIG. 5, can be driven by splitting strategy, including subscriber density and anticipated future changes. A distributed splitting approach may work well in lower-density areas or places with space constraints that limit fiber optic cable sizes. A centralized splitting approach may provide less stranded ports, and efficiently utilize network electronics.

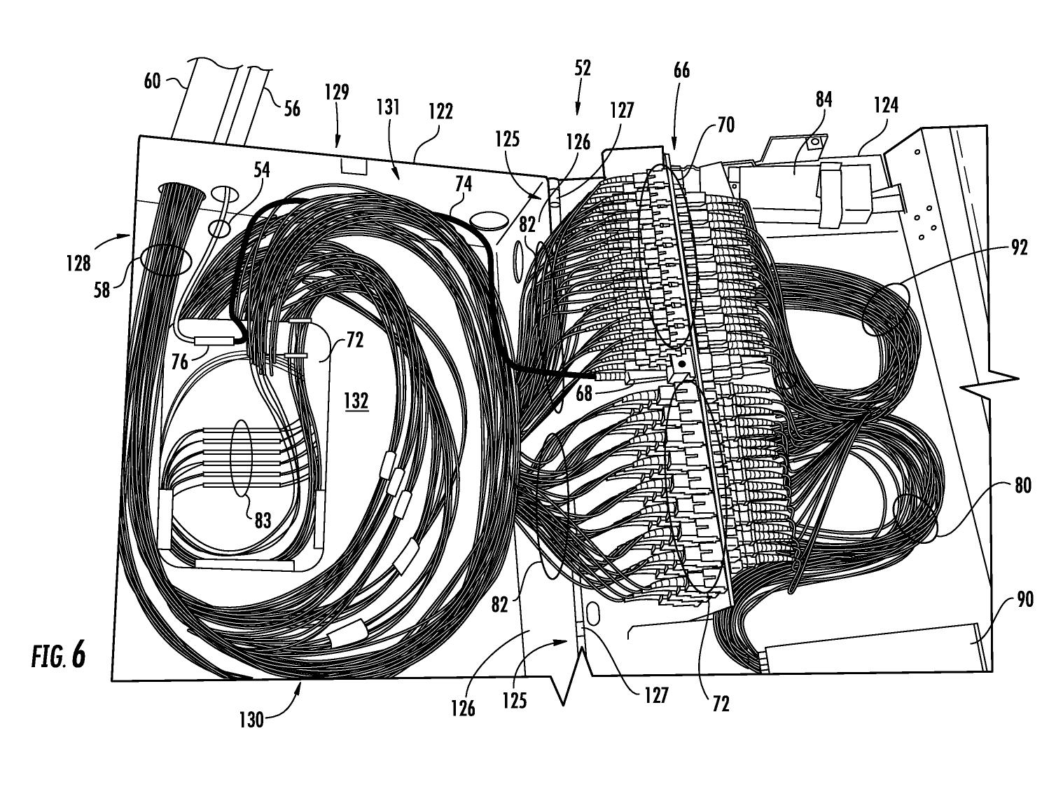

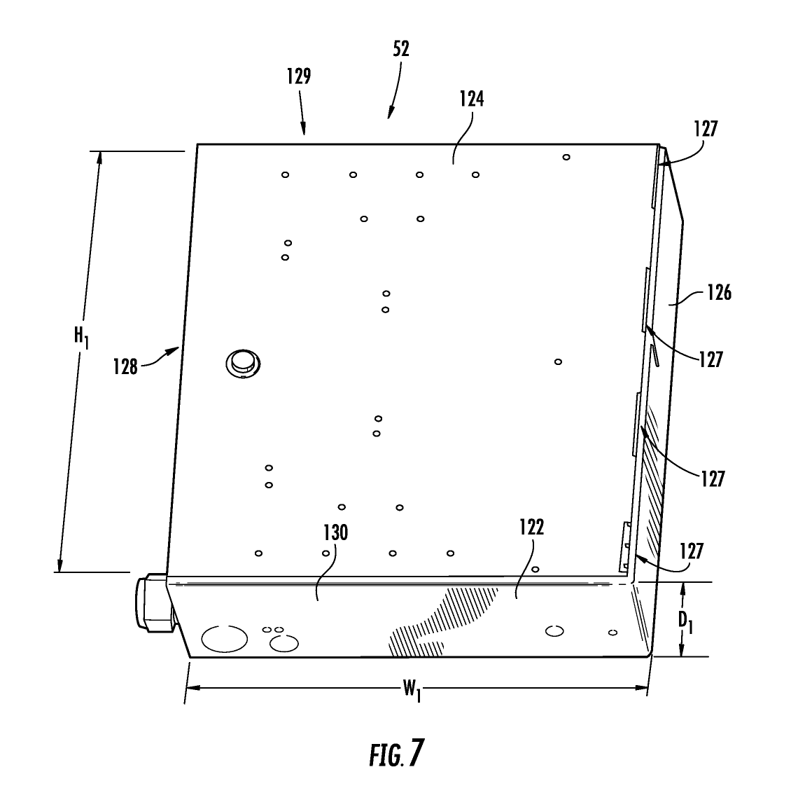

FIGS. 6 and 7 illustrate a schematic view of an example fiber optic terminal that may be provided as the fiber optic terminal 52 in FIGS. 3-5 and will be described below in this regard. However, note that the subscriber-side fiber optic terminal 52 illustrated in FIGS. 6 and 7 and the components provided therein may be provided in the network-side fiber optic terminal 102 in FIG. 5 as well. In this regard, the subscriber-side fiber optic terminal 52 illustrated in FIG. 6 comprises a base 122 and a terminal cover 124 hingedly affixed to the base 122 and opened thereon. The base 122 and the terminal cover 124 may be made of a rigid material, such as aluminum, plastic, or thermoplastic, as examples. The base 122 and the terminal cover 124 serve to close off and protect the internal components of the subscriber-side fiber optic terminal 52 when the terminal cover 124 is closed on the base 122, as illustrated in FIG. 7.

With continuing reference to FIG. 6, the terminal cover 124 is generally rectangular in this embodiment, although other shapes are possible. The terminal cover 124 in this embodiment is hingedly affixed to the base 122 of similar form along an edge 125 of a right side wall 126 at one or more hinge locations 127 (see also, FIG. 7). In this manner, the terminal cover 124 can be rotated about the hinge locations 127 when the terminal cover 124 is opened from the base 122. The base 122 is also comprised of a left side wall 128 disposed opposite and generally parallel to the right side wall 126, both of which are attached or interconnected on ends to a top side wall 129 and bottom side wall 130 (see also, FIG. 7). The right side wall 126, left side wall 128, top side wall 129 and bottom side wall 130 are either attached as separate pieces, or portions bent upward from a single sheet of material in planes orthogonal or substantially orthogonal about a back wall 131. In this manner, an interior chamber 132 is formed within the base 122. The interior chamber 132 provides room for routing and/or storage of network-side and subscriber-side fiber optic cables 56, 60 and the network-side and subscriber-side optical fibers 54, 58 therein and making optical interconnections between the two, including through any intermediate optical components that may be provided in the subscriber-side fiber optic terminal 52, as will be described below.

With continuing reference to FIGS. 6 and 7, a technician can open the terminal cover 124 to access the interior chamber 132 of the subscriber-side fiber optic terminal 52, such as to install or reconfigure optical interconnections within the subscriber-side fiber optic terminal 52. After completion, the terminal cover 124 can be closed against the base 122 to close the subscriber-side fiber optic terminal 52, thus closing off access to the interior chamber 132. When the terminal cover 124 is closed in this example, as illustrated in FIG. 7, the subscriber-side fiber optic terminal 52 has the approximate dimensions of four hundred thirty (430) millimeters (mm) height (H₁), four hundred (400) mm width (W₁), and one hundred thirty-five (135) mm depth (D₁). However, the subscriber-side fiber optic terminal 52 is not limited to these dimensions and any dimensions desired are possible.

As illustrated in FIG. 6 and discussed in more detail herein, the subscriber-side fiber optic terminal 52 and its internal components facilitate making optical connections between optical fiber(s) provided by one or more network-side fiber optic cables 56 and one or more subscriber-side fiber optic cables 60 to establish a connection between an end subscriber and a fiber optic network. Both the network-side fiber optic cable 56 and the subscriber-side fiber optic cable 60 may be distribution cables. In this regard, as illustrated by example in FIG. 6, the network-side fiber optic cable 56 provides the one or more network-side optical fibers 54 configured to be optically connected to a fiber optic network for carrying optical signals to and from the fiber optic network. The subscriber-side fiber optic cable 60 also contains the subscriber-side optical fibers 58 which are configured to be run to or towards end subscribers directly or through one or more intermediate terminals and/or other optical components. Thus, when a network-side optical fiber(s) 54 provided in the network-side fiber optic cable 56 is optically connected to a subscriber-side optical fiber(s) 58 provided in the subscriber-side fiber optic cable 60 within the subscriber-side fiber optic terminal 52 as previously discussed, an optical connection can be established between a subscriber and a fiber optic network.

The one or more network-side optical fibers 54 from the network-side fiber optic cable 56 and the one or more subscriber-side optical fibers 58 from the subscriber-side fiber optic cable 60 are optically connected to each other at the fiber optic connection panel 66. The fiber optic connection panel 66 can be a panel or module that contains or supports a plurality of optical fiber connections. As previously discussed, the fiber optic connection panel 66 support one or more input fiber optic adapters 68 and output fiber optic adapters 70 for supporting optical fiber connections. The input and output fiber optic adapters 68, 70 support making optical connections between one or more network-side optical fibers 54 and the subscriber-side optical fibers 58. The subscriber-side fiber optic terminal 52 illustrated in FIG. 6 contains the optical splitters 84, 90 provided in the subscriber-side fiber optic terminal 52 illustrated in FIG. 6 and previously described. The remaining components illustrated in the subscriber-side fiber optic terminal 52 in FIG. 6 are the same components previously described above with regard to FIGS. 3 and 4 and thus will not be re-described here.

The network services that can be provided to subscribers include, but are not limited to, RFoG, ATM PON (APON), Broadband PON (BPON), EPON, GPON, 10G-EPON, 10G-GPON, and WDM-PON. The fiber optic terminals described herein can include, but are not limited to, LCPs and FDTs. For example, the fiber optic terminal as used herein can be a splice terminal, patch terminal or the like, or any combination thereof. If fiber optic connectors and/or adapters are provided in the fiber optic terminals, the fiber optic connectors and/or adapters may be for any type of optical connector, including but not limited to an LC, SC, MTP, FC, ST, MU, or MTRJ, without limitation. If optical splitters are provided in the fiber optic terminals, the optical splitters can be of any type or configuration, including without limitation, 1×2, 1×4, 1×8, 1×16, 1×32, 1×64, 1×128, and 2×2.

The fiber optic terminals disclosed herein may be used for any fiber optic distribution application, including but not limited to directly or intermediately routing fiber optic cables and optical fibers from a fiber optic network(s) to subscriber premises and end subscribers, including but not limited to various fiber-to-the-premises (FTTP), fiber-to-the-home (FTTH), fiber-to-the-business (FTTB), and other fiber initiatives (generally described as FTTx). Subscriber premises include, but are not limited to single-dwelling units (SDU), multi-dwelling units (MDU), businesses, and/or other facilities or buildings. The fiber optic terminals may be installed in any location, including an aerial location, buried, or disposed in a larger enclosure, such as a ground pedestal.

The network-side and subscriber-side fiber optic cables may be any type of fiber optic cable and include any type of optical fibers in any form. Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive optical fiber is ClearCurve® Multimode fiber commercially available from Corning Incorporated.

Many modifications and other embodiments of the embodiments set forth herein will come to mind to one skilled in the art to which the embodiments pertain having the benefit of the teachings presented in the foregoing descriptions and the associated drawings. These modifications include, but are not limited to, the type or different network services provided or overlays of services, the type or number of fiber optic terminals, the type or number of optical fibers or fiber optic cables carrying optical fibers to and from fiber optic terminals, whether different network services are provided through connectors, connection panels, or optical splitters, and/or whether different network services are provided to subscribers in a centralized or distributed manner.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A fiber optic terminal, comprising:
a first optical path connected to a first network-side optical fiber providing a first network service to a first subscriber-side optical fiber; and
a second optical path connected to a second network-side optical fiber providing a second network service different from the first network service to a second subscriber-side optical fiber.

2. The fiber optic terminal of claim 1, wherein the first optical path is not homogeneous with the second optical path.

3. The fiber optic terminal of claim 1, wherein the first optical path includes a first non-split fiber optic connection.

4. The fiber optic terminal of claim 1, wherein the second optical path includes a second non-split fiber optic connection.

5. The fiber optic terminal of claim 1, wherein the first optical path includes a first optical splitter.

6. The fiber optic terminal of claim 5, wherein the second optical path includes a second optical splitter.

7. The fiber optic terminal of claim 1, wherein the first network service is comprised of optical signals at a first wavelength in the first optical path overlaid on optical signals at a second wavelength different from the first wavelength in the first optical path.

8. The fiber optic terminal of claim 1, wherein at least one of the first optical path and the second optical path includes at least one fiber optic connector.

9. The fiber optic terminal of claim 8, further comprising at least one parking area configured to receive the at least one fiber optic connector when not connected to at least one of the first subscriber-side optical fiber and the second subscriber-side optical fiber.

10. The fiber optic terminal of claim 1, wherein the first network service is a service comprised from the group consisting of Asynchronous Transfer Mode (ATM) Passive Optical Network (PON) (APON), Broadband PON (BPON), Ethernet PON (EPON), Gigabit PON (GPON), ten (10) Gigabit EPON (10G-EPON), 10G-GPON, WDM-based network services, and Radio Frequency over Glass (RFoG).

11. A method of providing at least two different network services to subscribers supported by a fiber optic terminal, comprising:
providing a fiber optic terminal;
connecting a first optical path in the fiber optic terminal to a first network-side optical fiber providing a first network service;
connecting the first optical path to at least one first subscriber-side optical fiber to provide the first network service to at least one first subscriber connected to the at least one first subscriber-side optical fiber; and
connecting a second optical path in the fiber optic terminal to a second network-side optical fiber providing a second network service different from the first network service.

12. The method of claim 11, wherein the first optical path is not homogeneous with the second optical path.

13. The method of claim 11, further comprising connecting the second optical path to at least one second subscriber-side optical fiber to provide the second network service to at least one second subscriber connected to the at least one second subscriber-side optical fiber.

14. The method of claim 11, wherein the at least one first subscriber-side optical fiber comprises a plurality of first subscriber-side optical fibers; and
further comprising splitting the first network service in the first optical path to the plurality of first subscriber-side optical fibers.

15. The method of claim 11, further comprising changing the connection of the first optical path from the at least one first subscriber-side optical fiber to at least one second subscriber-side optical fiber connected to the second optical path to provide the second network service to the at least one first subscriber.

16. A fiber optic system, comprising:
a network-side fiber optic terminal, comprising:
a first network-side optical path connected to a first network-side optical fiber providing a first network service to a first optical fiber; and
a second network-side optical path connected to a second network-side optical fiber providing a second network service different from the first network service to a second optical fiber; and
a first subscriber-side fiber optic terminal comprising a first optical path connected to the first optical fiber to provide the first network service to at least one first subscriber connected to the first subscriber-side fiber optic terminal.

17. The fiber optic system of claim 16, wherein the first subscriber-side fiber optic terminal is configured to provide the second network service to the at least one first subscriber by removing the connection of the first optical path to the first optical fiber and connecting the first optical path to the second optical fiber.

18. The fiber optic system of claim 16, further comprising a second subscriber-side fiber optic terminal comprising a second optical path connected to the first optical fiber to provide the first network service to at least one subscriber connected to the first subscriber-side fiber optic terminal.

19. The fiber optic system of claim 16, further comprising a second subscriber-side fiber optic terminal comprising a second optical path connected to the second optical fiber to provide the second network service to at least one subscriber connected to the first subscriber-side fiber optic terminal.

20. The fiber optic system of claim 16, wherein the first network-side optical path includes a first optical splitter.

21. The fiber optic terminal of claim 20, wherein the second network-side optical path includes a second optical splitter.
